(19) United States
(12) Patent Application Publication
(10) Pub. No.: US 2012/0140981 A1
(43) Pub. Date: Jun. 7, 2012

(54) System and Method for Combining Visible and Hyperspectral Imaging with Pattern Recognition Techniques for Improved Detection of Threats

(75) Inventors: Myles P. Berkman, Miami, FL (US); Charles W. Gardner, Gibsonia, PA (US)

(73) Assignee: Chemlmage Corporation, Pittsburgh, PA (US)

(21) Appl. No.: 12/504,914

(22) Filed: Jul. 17, 2009

Related U.S. Application Data
(60) Provisional application No. 61/081,567, filed on Jul. 17, 2008.

(51) Int. Cl. G06K 9/00; H04N 7/18

(52) U.S. Cl. 382/103; 348/61; 348/E07.085

(57) ABSTRACT

Systems and method for detecting unknown samples wherein pattern recognition algorithms are applied to a visible image of a first target area comprising a first unknown sample to thereby generate a first set of target data. If comparison of the first set of target data to reference data results in a match, the first unknown is identified and a hyperspectral image of a second target area comprising a second unknown sample is obtained to generate a second set of test data. If comparison of the second set of test data to reference data results in a match, the second unknown sample is identified as a known material. Identification of an unknown through hyperspectral imaging can also trigger the visible camera to obtain an image. In addition, the visible and hyperspectral cameras can be run continuously to simultaneously obtain visible and hyperspectral images.

### RELATED APPLICATIONS

This application claims priority to U.S. Provisional Application No. 61/081,567, filed on Jul. 17, 2008, entitled “Combining Visible and NIR Chemical Imaging with Pattern Recognition Techniques for Improved Detection of Human-Borne Threats.”

### BACKGROUND OF THE INVENTION

This application relates generally to systems and method for the detection and identification of threat agents and other hazardous materials. The application relates more specifically to the detection and identification of human-borne or vehicle borne threat agents using visible and hyperspectral imaging. This application also relates to systems and methods for the recognition of facial features or other distinguishing characteristics of an individual, or item associated with an individual, and to the detection of explosives, explosive residues, and other biological, chemical or hazardous materials.

Spectroscopic imaging combines digital imaging and molecular spectroscopy techniques, which can include Raman scattering, fluorescence, photoluminescence, ultraviolet, visible and infrared absorption spectroscopies. When applied to the chemical analysis of materials, spectroscopic imaging is commonly referred to as chemical imaging. Instruments for performing spectroscopic (i.e. chemical) imaging typically comprise an illumination source, image gathering optics, focal plane array imaging detectors and imaging spectrometers.

In general, the sample size determines the choice of image gathering optic. For example, a microscope is typically employed for the analysis of sub micron to millimeter spatial dimension samples. For larger objects, in the range of millimeter to meter dimensions, macro lens optics are appropriate. For samples located within relatively inaccessible environments, flexible fiberscope or rigid borescopes can be employed. For very large scale objects, such as planetary objects, telescopes are appropriate image gathering optics.

For detection of images formed by the various optical systems, two-dimensional, imaging focal plane array (FPA) detectors are typically employed. The choice of FPA detector is governed by the spectroscopic technique employed to characterize the sample of interest. For example, silicon (Si) charge-coupled device (CCD) detectors or CMOS detectors are typically employed with visible wavelength fluorescence and Raman spectroscopic imaging systems, while indium gallium arsenide (InGaAs) FPA detectors are typically employed with near-infrared spectroscopic imaging systems.

Spectroscopic imaging of a sample can be implemented by one of two methods. First, a point-source illumination can be provided on the sample to measure the spectra at each point of the illuminated area. Second, method of spectroscopic imaging collects spectra over the entire area encompassing the sample simultaneously using an electronically tunable optical imaging filter such as an acousto-optic tunable filter (AOTF), a multi-conjugate tunable filter (MCF), or a liquid crystal tunable filter (“LCTF”). Here, the organic material in such optical filters is actively aligned by applied voltages to produce the desired bandpass and transmission function. The spectra obtained for each pixel of such an image thereby forms a complex data set referred to as a hyperspectral image which contains the intensity values at numerous wavelengths or the wavelength dependence of each pixel element in this image.

### SUMMARY

The present disclosure provides for systems and methods for the detection and identification of threat agents and other hazardous materials. This application provides for the fusion of visible camera data and hyperspectral camera data, coupled with pattern recognition algorithms, for the standoff detection of human and vehicle-borne threats. In general, this system and method allows the association of a chemical image and the chemical information it contains with a specific visible image pattern. For example, a human threat can be detected by their facial features or by the presence of a hazardous chemical or explosive residue on their clothing or person. Combining systems and methods used in identifying threats with pattern recognition algorithms, enhances the capabilities of such systems and methods and results in more reliable threat identification. The coupling of these techniques, either simultaneously or consecutively, allows more reliable threat identification, especially when operated in a standoff or on-the-move detection mode.

The systems and methods of the present disclosure can be used to detect and identify one or more unknown samples of interest. In one embodiment, the unknown sample is found in a target area, which can be any region of interest of a scene. For example, a target area may comprise an individual, a part of an individual (i.e., a face, a hand, an arm, etc.) or an article associated with an individual (i.e., clothing, suitcase, ticket, passport, etc.). A target area may also comprise a vehicle (i.e., a car, a truck, a tank, an airplane, a boat, etc.) or other object in a scene (building, tree, etc.). It is recognized that any region of interest of a scene may be selected as a target area and the systems and methods of the present disclosure are not limited to the examples set forth herein, which are provided for illustrative purposes.

The unknown sample may be any chemical, biological, explosive, or other hazardous material or residue. The unknown sample may also be an individual, a part of an individual, or an article associated with an individual. In such an embodiment, the systems and methods of the present disclosure can be used to match said individual to one or more suspect individuals in a reference library. In addition to facial features, other distinguishing characteristics can be used in detecting and identifying the individual. The unknown sample can also be a vehicle or other object of interest.

In one embodiment, one or more target areas can be selected on the same individual or object. For example, a first target area may comprise an individual's face and a second target area may comprise an individual's hand. In such an embodiment, the first unknown sample may comprise the facial features of the individual's face. The application of pattern recognition algorithms to a visible image of the first target area can result in a first set of test data that can be compared to the reference data of the reference library to identify the individual as one or more suspect individuals. If such identification is made, the hyperspectral imaging camera can obtain a hyperspectral image of a second target area (e.g., the individual's hand) to obtain a second set of test data representative of a second unknown sample. In one embodiment, this second unknown sample may comprise explosive residue, which can be identified by comparing the second set of test data to the reference data of the reference library. Such coupling of visible imaging and hyperspectral imaging can provide information from different types of data (e.g. face recognition and explosive residue detection), leading to the association of a specific person to an event such as an explosion.

In one embodiment the hyperspectral image is an image selected from the group consisting of: fluorescence, infrared, short wave infrared (SWIR) near infrared (NIR), mid infrared, ultraviolet (UV), Raman, and combinations thereof.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure.

In the drawings:

FIG. 1 illustrates a system of the present disclosure.

FIG. 2 illustrates a method of the present disclosure.

FIG. 3 illustrates a method of the present disclosure.

FIG. 4 illustrates a method of the present disclosure.

### DETAILED DESCRIPTION

Reference will now be made in detail to the embodiments of the present disclosure, examples of which are illustrated in the accompanying drawings. Wherever possible, the same reference numbers will be used throughout the drawings to refer to the same or like parts.

The present disclosure provides for systems for identifying an unknown sample. In one embodiment, the system comprises: an illumination source; an image collection optics; a dichroic beamsplitter; a hyperspectral imaging system; a first lens located between said dichroic beamsplitter and said hyperspectral imaging system; a hyperspectral image processor; a visible light camera; a second lens located between said dichroic beamsplitter and said visible light camera; a visible image processor; a sensor fusion engine; and a threat display.

In one embodiment, the hyperspectral imaging system further comprises a tunable filter and a hyperspectral camera. The tunable filter can be a filter selected from the group consisting of: Fabry Perot angle tuned filter, an acousto-optic tunable filter, a liquid crystal tunable filter, a Lyot filter, an Evans split element liquid crystal tunable filter, a Solc liquid crystal tunable filter, a fixed wavelength Fabry Perot tunable filter, an air-tuned Fabry Perot tunable filter, a mechanically-tuned Fabry Perot tunable filter, a liquid crystal Fabry Perot tunable filter, and combinations thereof.

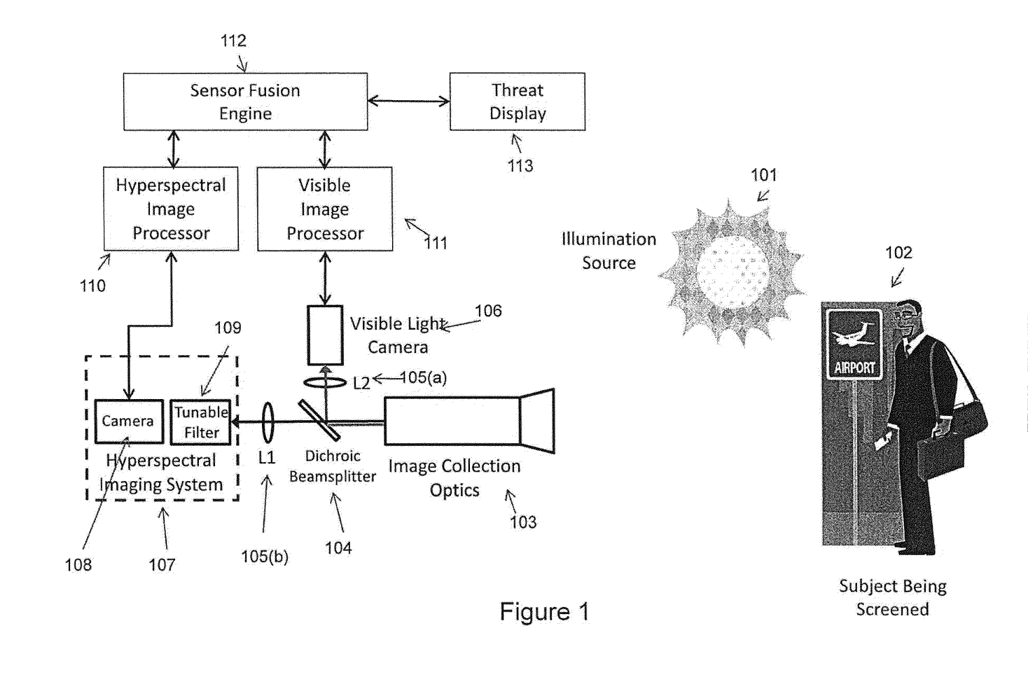

A schematic layout of an exemplary system 100 is illustrated in FIG. 1. An illumination source 101 is configured to illuminate a target area having an unknown sample 102 (i.e., a subject being screened), producing photons from different locations on or within the unknown sample. Image collection optics 103 collects these emitted photons. A dichroic beamsplitter 104 reflects a specified spectral region while transmitting another specified spectral region through a lens (L1 105(b) and L2 105(a)) to one or more detectors or through a filter and then to a detector. In the system embodied in FIG. 1, a visible light camera 106 and a hyperspectral imaging camera 108 are used as detectors. However, the detector can be selected from the group consisting of: a CCD detector, a CMOS detector, a InGaAs detector, and a InSb detector, and a InSb detector. Referring again to FIG. 1, a tunable filter 109 filters the light as it passes from the dichoric beamsplitter 104, though a lens 105(b) (L1), to the hyperspectral imaging camera 108. The hyperspectral imaging camera 108 and the tunable filter 109 collectively made up the hyperspectral imaging system 107. A visible image processor 111 and a hyperspectral image processor 110 process the data from the associated visible light camera 106 and hyperspectral image camera 108. A sensor fusion engine 112 collects information from one or both of the visible image processor 111 and the hyperspectral image processor 110 and generates a threat display 113.

FIG. 1 illustrates one contemplated use for the systems and methods disclosed herein where the illumination source 101 is the sun and the unknown sample 102 is a person of interest. However, the present disclosure also contemplates that a laser light or other illumination source known in the art can be used to illuminate an area of interest containing a sample. Also, the sample being screened can include a vehicle, a person, a part of a person, clothing or other item associated with a person (i.e., suitcase, ticket, passport, etc.).

The present disclosure provides for the fusion of different types of data (i.e., visible camera data and hyperspectral camera data). In one embodiment, the data fusion method comprises: providing a library having a plurality of sublibraries wherein each sublibrary contains a plurality of reference data sets generated by a corresponding one of a plurality of spectroscopic data generating instruments associated with the sublibrary. Each reference data set characterizes a corresponding known material. A plurality of test data sets is provided that is characteristic of an unknown material, wherein each test data set is generated by one or more of the plurality of spectroscopic data generating instruments. For each test data set, each sublibrary is searched where the sublibrary is associated with the spectroscopic data generating instrument used to generate the test data set. A corresponding set of scores for each searched sublibrary is produced, wherein each score in the set of scores indicates a likelihood of a match between one of the plurality of reference data sets in the searched sublibrary and the test data set. A set of relative probability values is calculated for each searched sublibrary based on the set of scores for each searched sublibrary. All relative probability values for each searched sublibrary are fused producing a set of final probability values that are used in determining whether the unknown material is represented through a known material characterized in the library. A highest final probability value is selected from the set of final probability values and compared to a minimum confidence value. The known material represented in the libraries having the highest final probability value is reported, if the highest final probability value is greater than or equal to the minimum confidence value. Such methodologies are more fully described in U.S. patent application Ser. No. 11/450,138, entitled “Forensic Integrated Search Technology”, which is hereby incorporated by reference in its entirety. Other methodologies that may be used are more fully described in U.S. patent application Ser. No. 12/017,445, entitled “Forensic Integrated Search Technology with Instrument Weight Factor Determination” and U.S. patent application Ser. No. 12/196,921, entitled “Adaptive Method for Outlier Detection and Spectral Library Augmentations”, which are hereby incorporated by reference in their entireties.

In another embodiment, the system may be modified by the addition of a Fiber Array Spectral Translator (“FAST”) system. The FAST system can provide faster real-time analysis for rapid detection, classification, identification, and visualization of, for example, hazardous agents, biological warfare agents, chemical warfare agents, and pathogenic microorganisms, as well as non-threatening objects, elements, and compounds. FAST technology can acquire a few to thousands of full spectral range, spatially resolved spectra simultaneously, This may be done by focusing a spectroscopic image onto a two-dimensional array of optical fibers that are drawn into a one-dimensional distal array with, for example, serpentine ordering. The one-dimensional fiber stack is coupled to an imaging spectrograph. Software is used to extract the spectral/spatial information that is embedded in a single CCD image frame.

One of the fundamental advantages of this method over other spectroscopic methods is speed of analysis. A complete spectroscopic imaging data set can be acquired in the amount of time it takes to generate a single spectrum from a given material. FAST can be implemented with multiple detectors. Color-coded FAST spectroscopic images can be superimposed on other high-spatial resolution gray-scale images to provide significant insight into the morphology and chemistry of the sample.

The FAST system allows for massively parallel acquisition of full-spectral images. A FAST fiber bundle may feed optical information from is two-dimensional non-linear imaging end (which can be in any non-linear configuration, e.g., circular, square, rectangular, etc.) to its one-dimensional linear distal end. The distal end feeds the optical information into associated detector rows. The detector may be a CCD detector having a fixed number of rows with each row having a predetermined number of pixels. For example, in a 1024-width square detector, there will be 1024 pixels (related to, for example, 1024 spectral wavelengths) per each of the 1024 rows.

The present disclosure also provides for methods of detecting human-borne or vehicle-borne threats. One method comprises illuminating an unknown sample to thereby produce photons emitted, scattered, absorbed or reflected from different locations on or within the unknown sample. This unknown sample can be an individual, or part of the individual such as the face. The unknown sample can also be a vehicle, such as a car or plane, or another entity. The photons emitted, scattered, absorbed or reflected from the unknown sample are then analyzed using one or more of visible imaging and spectroscopic imaging methods. In one embodiment the photons emitted, scattered, absorbed or reflected are analyzed using near infrared spectroscopy to produce at least one of the following: a plurality of spatially resolved near infrared spectra and a plurality of wavelength resolved near infrared images. In another embodiment, the photons emitted, scattered, absorbed or reflected are analyzed using mid infrared spectroscopy to produce at least one of the following: a plurality of spatially resolved mid infrared spectra and a plurality of wavelength resolved mid infrared images. In another embodiment, the emitted, scattered, absorbed or reflected photons are analyzed sing fluorescence spectroscopy to produce at least one of the following: a plurality of spatially resolved fluorescence spectra and a plurality of wavelength resolved fluorescence images. In yet another embodiment, emitted, scattered, absorbed or reflected photons are analyzed using Raman spectroscopy to produce at least one of the following: a plurality of spatially resolved Raman spectra and a plurality of wavelength resolved Raman images. In another embodiment, the emitted, scattered, absorbed or reflected photons are analyzed using ultra violet spectroscopy to produce at least one of the following: a plurality of spatially accurate wavelength resolved ultra violet spectra and a plurality of spatially accurate wavelength resolved ultra violet images. In another embodiment, the emitted, scattered, absorbed or reflected photons are analyzed using visible spectroscopy to produce at least one of the following: a plurality of spatially accurate wavelength resolved visible spectra and a plurality of spatially accurate wavelength resolved images. This analysis produces test data this is compared to reference data by searching an associated reference library containing the reference data of interest.

The reference library search is performed using a similarity metric that compares the test data to the reference data of the searched reference library. In one embodiment, any similarity metric that produces a likelihood score may be used to perform the search. In another embodiment, the similarity metric includes one or more of an Euclidean distance metric, a spectral angle mapper metric, a spectral information divergence metric, and a Mahalanobis distance metric, principal component analysis (PCA), Cosine Correlation Analysis (CCA), multivariate curve resolution (MCR), Band T. Entropy Method (BTEM), and Adaptive Subspace Detector (ASD). The search results produce a corresponding set of scores for the searched library. Each score indicates a likelihood of a match between the test data and the reference data in the searched library. The set of scores produced are converted to a set of relative probability values. These probability values are used to determine whether the unknown sample is represented by a known individual or material in the library, and therefore a potential threat. To determine if the unknown sample is a potential threat, the highest probability value is then compared to a minimum confidence value. If the highest probability value is greater than or equal to the minimum confidence value, the known individual or material having the highest final probability value is reported.

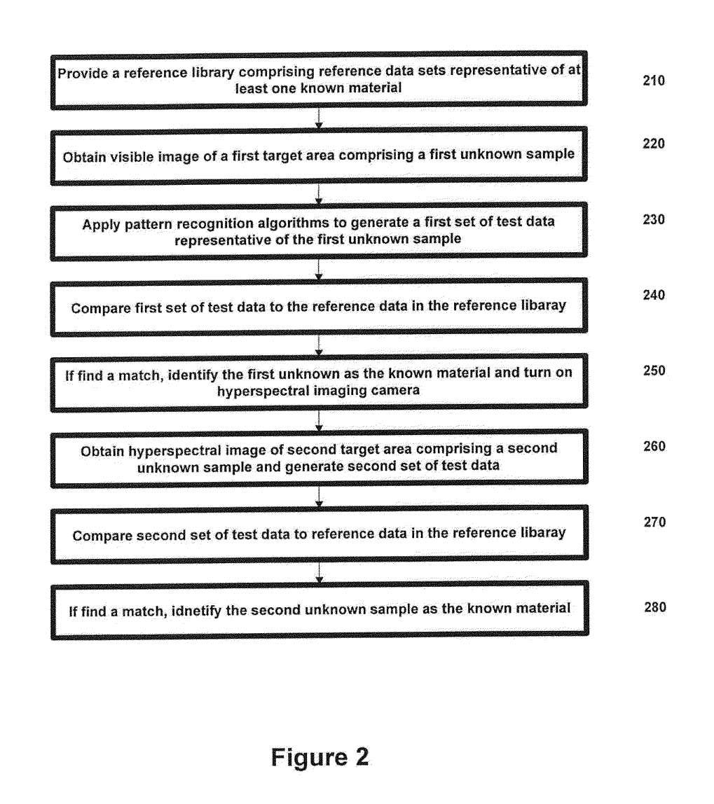

FIG. 2 illustrates one method of the present disclosure. A reference library is provided in step 210 wherein said reference library comprises reference data sets representative of at least one known material. In step 220 a visible image is obtained of a first target area wherein said first target area comprises a first unknown sample. Said visible image is obtained in step 220 by illuminating the first target area to thereby produce photons selected from the group consisting of: photons emitted by the sample, photons scattered by the sample, photons reflected by the sample, photons absorbed by the sample, and combinations thereof. The photons are assessed using a visible image camera to thereby produce the visible image. Pattern recognition algorithms are applied to the visible image in step 230 to thereby generate a first set of test data representative of said first unknown sample. The first set of test data is compared to the reference data of the reference library in step 240. If said comparing results in a match between the test data representative of the first unknown sample and a known material, step 250 identifies the first unknown material as the known material and triggers the hyperspectral imaging camera to turn on. In step 260 a hyperspectral image of a second target area is obtained wherein said second target area comprises a second unknown sample. The hyperspectral image is obtained by illuminating the second target area to thereby produce photons selected from the group consisting of: photons emitted by the sample, photons scattered by the sample, photons reflected by the sample, photons absorbed by the sample, and combinations thereof. The photons are then assessed using a hyperspectral imaging camera to thereby generate the hyperspectral image and generate a second set of test data representative of the second unknown sample. This second set of test data is compared to the reference data of the reference library in step 270. If the comparison results in a match between said second test data representative of a second unknown sample and a known material, the second unknown sample is identified as the known material in step 280.

In one embodiment, this method further comprises reporting match only if such comparison meets a minimum confidence value. If no match is found between the unknown sample and a known material in the reference library, a new target area can be selected for analysis.

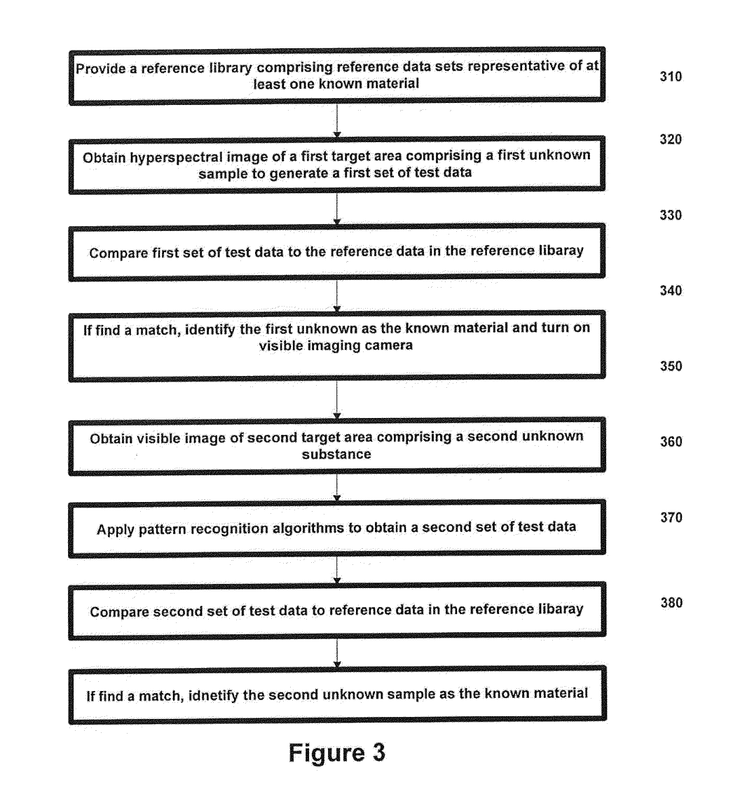

FIG. 3 illustrates another method provided for by the present disclosure. A reference library comprising reference data sets representative of at least one known material is provided in step 310. In step 320 a hyperspectral image of a first target area, comprising a first unknown sample, is obtained to generate a first set of test data representative of a first unknown sample. Said hyperspectral image is obtained by illuminating the first target area to thereby produce photons selected from the group consisting of: photons emitted by the sample, photons scattered by the sample, photons reflected by the sample, photons absorbed by the sample, and combinations thereof. The photons are then assessed using a hyperspectral imaging camera to thereby generate the hyperspectral image and generate a first set of test data representative of the first unknown sample. This first set of test data is compared to the reference data of the reference library in step 330. If there is a match between the first set of test data representative of the first unknown sample and a known material, the unknown sample is identified as the known material and a visible camera is triggered to turn on. A visible image of a second target area, comprising a second unknown sample, is obtained in step 350. The visible image is obtained by illuminating the second target area to thereby produce photons selected from the group consisting of: photons emitted by the sample, photons scattered by the sample, photons reflected by the sample, photons absorbed by the sample, and combinations thereof. The photons are assessed using the visible image camera to thereby generate the visible image. In step 360, pattern recognition algorithms are applied to the visible image to thereby generate a second set of test data representative of said second unknown material. The second set of test data is compared to the reference data in step 370. If there is a match between the second set of test data representative of said second unknown sample and a known material in the reference library, the second unknown sample is identified as the known material in step 380.

In another embodiment, a reference library comprising reference data sets representative of at least one known material is provided. A hyperspectral image of a first target area, comprising a first unknown sample is obtained to generate a first set of test data representative of a first unknown sample. Said hyperspectral image is obtained by illuminating the first target area to thereby produce photons selected from the group consisting of: photons emitted by the sample, photons reflected by the sample, photons absorbed by the sample, photons scattered by the sample, and combinations thereof. The photons are assessed using a hyperspectral imaging camera to thereby generate the hyperspectral image and generate a first set of test data representative of the first unknown sample. This first set of test data is compared to the reference data of the reference library. If there is a match between the first set of test data representative of the first unknown sample and a known material in the library, the unknown sample is identified as the known material and the visible camera is turned on. In this embodiment, the visible camera is equipped to follow an individual or object of interest as it moves from place to place. For example, if a first target area is a hand of an individual and a first unknown sample is an explosive residue found to match a known explosive residue in the reference library, the visible camera can be configured to follow the individual as they change locations. This embodiment allows for the tracking of a suspect or other object and gathers more information based on events that occur after an initial “hit” (match with a known material in the reference library). The camera can follow a target area or the individual/object as a whole. In one embodiment, after tracking a change in location, more test data can be generated using either the visible image camera or the hyperspectral image camera. In one embodiment, the same camera is used to track the change in location and obtain a visible image. In another embodiment, two or more different cameras can be used to track the change in location and obtain a visible image. In one embodiment, a video camera is used. In another embodiment, any camera known in the art can be used to track the target area or the individual/object as a whole.

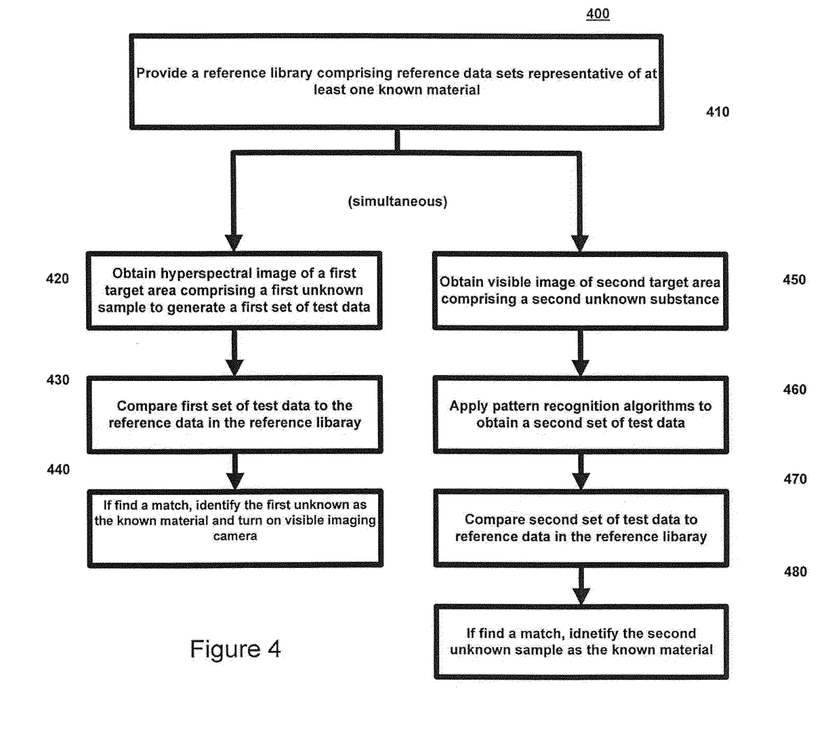

FIG. 4 illustrates another embodiment of the present disclosure wherein the visible camera and the hyperspectral camera are both run continuously. In one embodiment, the continuous acquisition of data results in simultaneously obtaining a visible image and a hyperspectral image. In step 410 a reference library is provided comprising reference data sets representative of at least one known material. A hyperspectral image of a first target area comprising a first unknown sample is obtained in step 420. The hyperspectral image is obtained by illuminating the first target area to thereby produce photons selected from the group consisting of: photons emitted by the sample, photons scattered by the sample, photons reflected by the sample, photons absorbed by the sample, and combinations thereof. The photons are then assessed using a hyperspectral imaging camera to thereby generate the hyperspectral image and generate a first set of test data representative of the second unknown sample. In step 430 the first set of test data is compared to the reference data in the reference library. If there is a match between the first set of test data of representative of the first unknown sample and a know material in the reference library, the first unknown sample is identified as the known material in step 440. At the same time the hyperspectral image camera is being run, the visible camera is also being run. In step 450 a visible image of a second target area comprising a second unknown sample is obtained. The visible image is obtained by illuminating the first target area to thereby produce photons selected from the group consisting of: photons emitted by the sample, photons scattered by the sample, photons reflected by the sample, photons absorbed by the sample, and combinations thereof. The photons are then assessed using a visible camera to thereby generate a visible image. In step 460 pattern recognition algorithms are applied to the visible image to generate a second set of test data representative of said second unknown sample. The second set of test data is compared to the reference data of the reference library in step 470. If there is a match between the second set of test data representative of said second unknown sample and a known material in the reference library, then said second unknown sample is identified as the known material.

In one embodiment, a set of relative probability values is calculated for each reference data set the first and second sets of test data are compared to. The relative probability values are fused producing a set of final probability values used to determine whether the unknown material is represented by a known material in the reference library. A highest final probability value is selected from the set of relative probability values and compared to a minimum confidence value. If the highest final probability value is greater than or equal to the minimum confidence value, unknown sample is identified as the known material represented by the associated reference data set.

The methods described herein provide for embodiments where the first target area and the second target area are the same and where the first target area and the second target area are different. The disclosure also provides for embodiments wherein the hyperspectral image is a hyperspectral NIR image and a hyperspectral fluorescent image.

In another embodiment of the present disclosure, said assessing said photons using a hyperspectral imaging device further comprises: obtaining a plurality of spatially accurate wavelength resolved spectra to thereby generate a third set of test data representative of the of ether the first or second unknown sample, wherein said spectra is selected from the group consisting of: spatially accurate wavelength resolved Raman spectra, spatially accurate wavelength resolved fluorescence spectra, spatially accurate wavelength resolved infrared spectra, spatially accurate wavelength resolved near infrared spectra, spatially accurate wavelength resolved mid infrared spectra, spatially accurate wavelength resolved ultra violet spectra, and combinations thereof; comparing said third set of test data to the reference data in the reference library; if said comparing results in a match between the first or second unknown sample and a known material, identifying said second unknown sample as the known material.

The present disclosure may be embodied in other specific forms without departing from the spirit or essential attributes of the disclosure. Accordingly, reference should be made to the appended claims, rather than the foregoing description is directed to the embodiments of the disclosure, it is noted that other variations and modification will be apparent o those skilled in the art, and may be made without departing from the spirit of the disclosure.

What is claimed:

1. A method for identifying an unknown sample comprising:
providing a reference library comprising a plurality of reference data sets, wherein each reference data set is representative of at least one known material;
illuminating a first target area, wherein said first target area comprises a first unknown sample, to thereby produce photons selected from the group consisting of: photons emitted by the sample, photons scattered by the sample, photons reflected by the sample, photons absorbed by the sample, and combinations thereof;
assessing said photons using a visible imaging device, wherein said assessing comprises:
obtaining a visible image of said first target area wherein said first target area comprises said first unknown sample,
applying pattern recognition algorithms to said visible image to thereby generate a first set of test data representative of the first unknown sample,
comparing said first set of test data to the reference data in the reference library,
if said comparing results in a match between the first unknown sample and a known material,
identifying said first unknown sample as the known material, and
illuminating a second target area, wherein said second target area comprises a second unknown sample, to thereby produce photons selected from the group consisting of: photons emitted by the sample, photons scattered by the sample, photons reflected by the sample, photons absorbed by the sample, and combinations thereof,
assessing said photons using a hyperspectral imaging device, wherein said assessing comprises:
obtaining a hyperspectral image of said second target area, wherein said second target area comprises a second unknown sample, to thereby generate a second set of test data representative of the second unknown sample,
comparing said second set of test data to the reference data in the reference library,
if said comparing results in a match between the second unknown sample and a known material, identifying said second unknown sample as the known material.

2. The method of claim 1 wherein said first target area and said second target area the same.

3. The method of claim 1 wherein said first target area is different from said second target area.

4. The method of claim 1 wherein said hyperspectral image is an image selected from the group consisting of: a hyperspectral near infrared image, a hyperspectral mid infrared image, a hyperspectral infrared image, a hyperspectral fluorescence image, a hyperspectral Raman image, a hyperspectral ultra violet image, and combinations thereof.

5. The method of claim 1 wherein said assessing said photons using a hyperspectral imaging device further comprises:
obtaining a plurality of spatially accurate wavelength resolved spectra to thereby generate a third set of test data representative of the second unknown sample, wherein said spectra is selected from the group consisting of: spatially accurate wavelength resolved Raman spectra, spatially accurate wavelength resolved fluorescence spectra, spatially accurate wavelength resolved infrared spectra, spatially accurate wavelength resolved near infrared spectra, spatially accurate wavelength resolved mid infrared spectra, spatially accurate wavelength resolved ultra violet spectra, and combinations thereof;
comparing said third set of test data to the reference data in the reference library;
if said comparing results in a match between the second unknown sample and a known material, identifying said second unknown sample as the known material.

6. A method for identifying an unknown sample comprising:
providing a reference library comprising a plurality of reference data sets, wherein each reference data set is representative of at least one known material;
illuminating a first target area, wherein said first target area comprises a first unknown sample, to thereby produce photons selected from the group consisting of: photons emitted by the sample, photons scattered by the sample, photons reflected by the sample, photons absorbed by the sample, and combinations thereof;
assessing said photons using a hyperspectral imaging device, wherein said assessing comprises:
obtaining a hyperspectral image of said first target area comprising said first unknown sample to thereby generate a first set of test data representative of said first unknown sample,
comparing said first set of test data to the reference data in the reference library,
if said comparing results in a match between the first unknown sample and a known material identifying said first unknown sample as the known material, and
illuminating a second target area, wherein said second target area comprises a second unknown sample, to thereby produce photons selected from the group consisting of: photons emitted by the sample, photons scattered by the sample, photons reflected by the sample, photons absorbed by the sample, and combinations thereof;
obtaining a visible image of a second target area, wherein said second target area comprises said second unknown sample,
applying pattern recognition algorithms to said visible image to thereby generate a second set of test data representative of the second unknown sample,
comparing said second set of test data to the reference data in the reference library,
if said comparing results in a match between the second unknown sample and a known material, identifying said second unknown sample as the known material.

7. The method of claim 6 wherein said comparing said first set of test data to the reference data in the reference library further comprises:
if said comparing results in a match between the first unknown sample and a know material, identifying said first unknown sample as the known material, and
tracking a change in location of said first target area comprising said first unknown sample using a camera.

8. The method of claim 6 wherein said first target area and said second target area is the same.

9. The method of claim 6 wherein said first target area is different from said second target area.

10. The method of claim 6 wherein said hyperspectral image is an image selected from the group consisting of: a hyperspectral near infrared image, a hyperspectral mid infrared image, a hyperspectral infrared image, a hyperspectral fluroesecence image, a hyperspectral Raman image, a hyperspectral ultra violet image, and combinations thereof.

11. The method of claim 6 wherein said assessing said photons using a hyperspectral imaging device further comprises:
obtaining a plurality of spatially accurate wavelength resolved spectra to thereby generate a third set of test data representative of the first unknown sample, wherein said spectra is selected from the group consisting of: spatially accurate wavelength resolved Raman spectra, spatially accurate wavelength resolved fluorescence spectra, spatially accurate wavelength resolved infrared spectra, spatially accurate wavelength resolved near infrared spectra, spatially accurate wavelength resolved mid infrared spectra, spatially accurate wavelength resolved ultra violet spectra, and combinations thereof;
comparing said third set of test data to the reference data in the reference library;
if said comparing results in a match between the first unknown sample and a known material, identifying said first unknown sample as the known material.

12. A method for identifying an unknown sample comprising:
providing a reference library comprising a plurality of reference data sets, wherein each reference data set is representative of at least one known material;
illuminating a first target area, wherein said first target area comprises a first unknown sample, to thereby produce photons selected from the group consisting of photons emitted by the sample, photons scattered by the sample, photons reflected by the sample, photons absorbed by the sample, and combinations thereof;
assessing said photons using a visible imaging device, wherein said assessing comprises:
obtaining a visible image of said first target area wherein said first target area comprises said first unknown sample,
applying pattern recognition algorithms to said visible image to thereby generate a first set of test data representative of the first unknown sample,
comparing said first set of test data to the reference data in the reference library,
if said comparing results in a match between the first unknown sample and a known material, identifying said first unknown sample as the known material;
illuminating a second target area, wherein said second target area comprises a second unknown sample, to thereby produce photons selected from the group consisting of: photons emitted by the sample, photons scattered by the sample, photons reflected by the sample, photons absorbed by the sample, and combinations thereof;
assessing said photons using a hyperspectral imaging camera, wherein said assessing comprises:
obtaining a hyperspectral image of a second target area, wherein said second target area comprises a second unknown sample, to thereby generate a second set of test data representative of the second unknown sample,
comparing said second set of test data to the reference data in the reference library,
if said comparing results in a match between the second unknown sample and a known material, identifying said second unknown sample as the known material; and
wherein said visible image and said hyperspectral image are obtained substantially simultaneously.

13. The method of claim 12 wherein said first target area and said second target area are the same.

14. The method of claim 12 wherein said first target area is different from said second target area.

15. The method of claim 12 wherein said hyperspectral image is an image selected from the group consisting of: a hyperspectral near infrared image, a hyperspectral mid infrared image, a hyperspectral infrared image, a hyperspectral fluroesecence image, a hyperspectral Raman image, a hyperspectral ultra violet image, and combinations thereof.

16. The method of claim 12 wherein said assessing said photons using a hyperspectral imaging device further comprises:
obtaining a plurality of spatially accurate wavelength resolved spectra to thereby generate a third set of test data representative of the second unknown sample, wherein said spectra is selected from the group consisting of: spatially accurate wavelength resolved Raman spectra, spatially accurate wavelength resolved fluorescence spectra, spatially accurate wavelength resolved infrared spectra, spatially accurate wavelength resolved near infrared spectra, spatially accurate wavelength resolved mid infrared spectra, spatially accurate wavelength resolved ultra violet spectra, and combinations thereof;
comparing said third set of test data to the reference data in the reference library;
if said comparing results in a match between the second unknown sample and a known material, identifying said second unknown sample as the known material.

17. System comprising:
an illumination source;
an image collection optics;
a dichroic beamsplitter;
a hyperspectral imaging system;
a first lens located between said dichroic beamsplitter and said hyperspectral imaging system;
a hyperspectral image processor;
a visible light camera;
a second lens located between said dichroic beamsplitter and said visible light camera;
a visible image processor;
a sensor fusion engine; and
a threat display.

18. The method of claim 17 wherein said hyperspectral imaging system further comprises:
a tunable filter; and
a hyperspectral camera.

19. The method of claim 17 wherein said tunable filter comprises a liquid crystal tunable filter, a Fabry Perot tunable filter, an acusto-optic tunable filter, a Lyot filter, an Evan's split element liquid crystal tunable filter, a Solc filter, and combinations thereof.
